(19) United States
(12) Patent Application Publication
(10) Pub. No.: US 2011/0202486 A1
(43) Pub. Date: Aug. 18, 2011

(54) Healthcare Information Technology System for Predicting Development of Cardiovascular Conditions

(76) Inventors: Glenn Fung, Madison, WI (US); Faisal Farooq, Norristown, PA (US); Bharat R. Rao, Berwyn, PA (US); Stephan B. Felix, Griesfwald (DE); Till Ittermann, Greifswald (DE); Heyo K. Kroemer, Neuenkirchen (DE); Rainer Rettig, Weitenhagen (DE); Henry Volzke, Stilow (DE)

(21) Appl. No.: 13/046,990

(22) Filed: Mar. 14, 2011

Related U.S. Application Data
(63) Continuation-in-part of application No. 12/506,583, filed on Jul. 21, 2009.
(60) Provisional application No. 61/392,156, filed on Oct. 12, 2010.
(60) Provisional application No. 61/313,446, filed on Mar. 12, 2010.

(51) Int. Cl. G06F 15/18; G06N 5/00; G06N 3/02

(52) U.S. Cl. 706/12; 706/46; 706/20; 706/47

(57) ABSTRACT

Described herein is a framework for predicting development of a cardiovascular condition of interest in a patient. The framework involves determining, based on prior domain knowledge relating to the cardiovascular condition of interest, a risk score as a function of patient data. The patient data may include both genetic data and non-genetic data. In one implementation, the risk score is used to categorize the patient into at least one of multiple risk categories, the multiple risk categories being associated with different strategies to prevent the onset of the cardiovascular condition. The results generated by the framework may be presented to a physician to facilitate interpretation, risk assessment and/or clinical decision support.

### CROSS-REFERENCE TO RELATED APPLICATIONS

The present application is a continuation-in-part application of U.S. Ser. No. 12/506,583, filed on Jul. 21, 2009. The present application also claims the benefit of U.S. provisional application no. 61/313,446 filed Mar. 12, 2010 and U.S. provisional application no. 61/392,156 filed Oct. 12, 2010; the entire contents of the above-referenced applications are herein incorporated by reference.

### TECHNICAL FIELD

The present disclosure relates generally to healthcare information technology (HIT) systems, and more particularly, to a combined diagnostics model for assessing the risk of a patient developing a cardiovascular condition.

### BACKGROUND

Hypertension or high blood pressure has been recognized as an important risk factor for vascular morbidity and mortality. Among the life-threatening cardiovascular conditions that may result from persistent hypertension, stroke and myocardial infarction (i.e. heart attack) are associated with the highest relative risk from hypertension and thus contribute largely to blood pressure-related mortality. Studies have shown that 13.5% of all deaths worldwide are attributable to high blood pressure. The global annual cost of uncontrolled blood pressure has been estimated to be almost 500 billion dollars. In the United States, expenditures for coronary heart disease were estimated to be more than $150 billions in 2008. This estimate takes into account not only the direct costs associated with the disease (e.g., doctors, hospitals, medication costs), but also indirect costs associated with lost productivity because of morbidity and mortality. It is reported that in 2009, there were an estimated number of 8,500,000 cases of myocardial infarction in the United States alone.

Similarly, expenditures for coronary heart disease in the U.S. were estimated to be more than $150 billions just a few years ago. This estimate takes into account not only the direct cost associated with disease (doctors, hospitals, medication costs) but also indirect costs associated with lost productivity because of morbidity and mortality. It is reported that in 2009 there were an estimated number of 8,500,000 cases of myocardial infarction in USA only.

To combat hypertension-related mortality, experts have suggested a combination of legislation, voluntary industry participation and mass media campaigns to educate the public on how to reduce the risk of hypertension by reducing salt consumption, as well as the use of generic antihypertensive medications to achieve a greater blood pressure reduction at lower cost. In addition, appropriate cost-effective preventive measures can be implemented by identifying individuals who are at high risk of developing hypertension.

Although the direct cause of hypertension is generally unknown, there are many factors that are believed to increase the risk of developing hypertension. Such factors include, for example, obesity, sedentary lifestyle, vitamin D deficiency, age, family history, and so forth. In order to formulate an accurate and informed diagnosis of hypertension risk, physicians have to take into consideration an ever-growing amount of data from many different sources, such as medical history reports, physical examinations, laboratory test results, imaging modalities, etc. As the number of information sources expands, manually extracting and assimilating all available diagnostic data, and assessing various treatment and patient management options, becomes more and more tedious, time consuming and error-prone.

Given the amount of data that has to be taken into account in each diagnosis, it is preferable that an automatic data mining technique should extract and summarize predictive information from large data sets. There is, however, little work in building statistical and data-mining based models for automatically predicting hypertension. In addition, the challenge that confronts any such effort is the lack of high-quality data that can be extracted or analyzed in any meaningful or reliable way. This is because most predictor variables are usually incomplete due to imperfect data collection processes, lack of accurate assessment and knowledge of patient factors, cost limitations related to equipment, and so forth. Most predictive methods fail in the presence of missing data or values.

In view of the foregoing, there exists a need for automated or semi-automated techniques to combine patient information from a variety of sources so as to accurately predict the development of a cardiovascular condition such as hypertension or myocardial infarction, and health complications associated with these conditions.

### SUMMARY

A framework for predicting development of a cardiovascular condition in a patient is described herein, The framework involves determining, based on prior domain knowledge relating to the cardiovascular condition of interest, a risk score as a function of patient data. The patient data may include both genetic data and non-genetic data. In one implementation, the risk score is used to categorize the patient into at least one of multiple risk categories, the multiple risk categories being associated with different strategies to prevent the onset of the cardiovascular condition. The results generated by the framework may be presented to a physician to facilitate interpretation, risk assessment and/or clinical decision support.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 shows an exemplary system;

FIG. 2 shows an exemplary method of predicting a cardiovascular condition;

FIG. 3 shows an exemplary method of determining a risk score;

FIG. 4 shows an exemplary Bayesian network-based model network;

FIGS. 5a and 5b show exemplary receiver operating curves; and

FIG. 6 shows an exemplary process for continuous monitoring, prevention and/or treatment of hypertension.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The following description sets forth one or more implementations of systems and methods that facilitate prediction of the development of a cardiovascular condition in a patient. In one implementation, a risk score generated by a predictive model is employed to classify patients (or subjects) into different risk categories, so as to facilitate formulation of more personalized preventive strategies according to the selected risk category. The predictive model may be constructed based on, for example, a probabilistic model such as a Bayesian network (BN). One of the major advantages of using BN-based predictive models is accurate prediction in the presence of missing values and interpretability of the predictive model, which will be discussed in more detail in the following description.

It is noted that, while a particular application directed to hypertension prediction may be shown, the technology is not limited to the specific embodiment illustrated. The present technology has application to other types of cardiovascular conditions of interest, such as different types of hypertension (e.g., essential, secondary, malignant, etc.), or other types of conditions that may be associated with or precipitated by the onset of hypertension, such as myocardial infarction (i.e. heart attack), stroke or any other coronary heart condition, For instance, the present technology may be used to present an accurate and personalized prediction of the risk of a patient developing myocardial infarction (MI) in the near future.

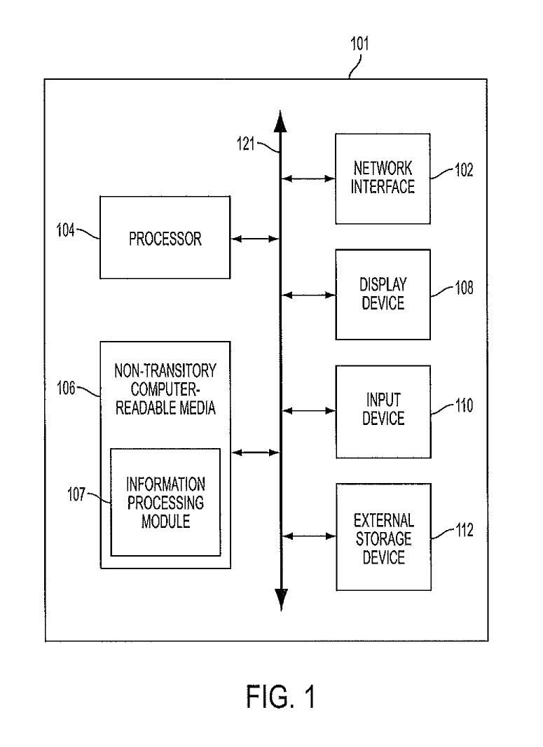

FIG. 1 shows a block diagram illustrating an exemplary system 101 for implementing the framework as described herein. In one implementation, system 101 serves as a healthcare information technology (HIT) system that manages health care information, data and knowledge for communication and decision making. System 101 may be a desktop personal computer, a portable laptop computer, another portable device, a mini-computer, a mainframe computer, a server, a storage system, a dedicated digital appliance, or another device having a storage sub-system configured to store a collection of digital data items. In one implementation, system 101 includes a processor 104 coupled to one or more non-transitory computer-readable media 106 (e.g., computer storage or memory), network interface 102, display device 108 (e.g., monitor) and various input devices 110 (e.g., mouse or keyboard) via an input-output interface 121. System 101 may further include support circuits such as a cache, power supply, clock circuits and a communications bus.

It should be appreciated that the present technology may be implemented in various forms of hardware, software, firmware, special purpose processors, or a combination thereof. In one implementation, the techniques described herein are implemented as computer-readable program code tangibly embodied in non-transitory computer-readable media 106. In particular, the techniques described herein may be implemented by the information processing module 107. Computer-readable media 106 includes, for example, random access memory (RAM), read only memory (ROM), magnetic floppy disk, flash memory, and other types of memories, or a combination thereof. The computer-readable program code is executed by processor 104 to retrieve and process data (e.g., patient data, records) from, for example, a database implemented in external storage device 112. System 101 is a general-purpose computer system that becomes a specific purpose computer system when executing the computer readable program code. The computer-readable program code is not intended to be limited to any particular programming language and implementation thereof. It will be appreciated that a variety of programming languages and coding thereof may be used to implement the teachings of the disclosure contained herein.

In one implementation, system 101 also includes an operating system and microinstruction code stored in the non-transitory computer readable media 106. The various techniques described herein may be implemented either as part of the microinstruction code or as part of an application program or software product, or a combination thereof, which is executed via the operating system. Various other peripheral devices, such as additional data storage devices and printing devices, may be connected to system 101.

In one implementation, the external storage device 112 comprises non-transitory computer readable media, such as a hard disk or other types of memories, for storing the database. The database may be managed by a database management system (DBMS). It should be appreciated that the external storage device 112 may also be implemented on one or more additional computer systems. For example, the external storage device 112 may include a data warehouse system residing on a separate computer system.

System 101 may be a standalone system, or further connected, via the network interface 102, to other workstations, servers or network (not shown) over a wired or wireless network. The network interface 102 may be a hard-wired interface or any device suitable for transmitting information to and from another device, such as a universal asynchronous receiver/transmitter (UART), a parallel digital interface, a software interface or any combination of known or later developed software and hardware. The network interface 102 may be linked to various types of wired or wireless networks, including a local area network (LAN), a wide area network (WAN), an intranet, a virtual private network (VPN), and the Internet.

Those skilled in the art will appreciate that other alternative computing environments may be used without departing from the spirit and scope of the present invention.

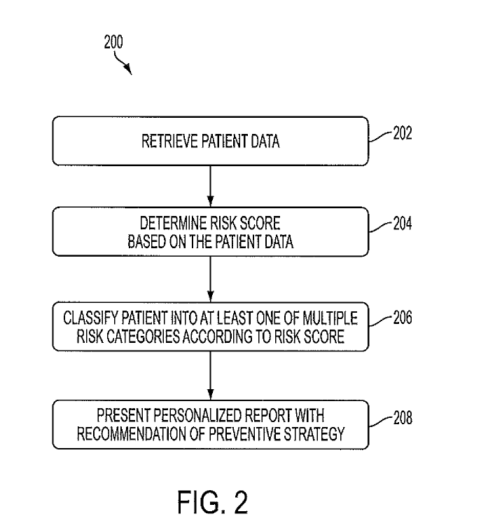

FIG. 2 shows an exemplary method 200 for facilitating prediction of a cardiovascular condition of interest, such as hypertension (e.g., essential hypertension, secondary hypertension, malignant hypertension, etc.) or any condition that may be associated with or precipitated by the onset of hypertension, such as myocardial infarction (MI) or stroke. In one implementation, the exemplary method 200 provides decision or interpretation support at the point-of-care for patients considered at risk of developing the cardiovascular condition in the near future. Such support will aid the primary care physician in determining which preventive steps should be taken to avoid or delay the onset of the cardiovascular condition of interest. The present framework is particularly useful for treating subjects having a family history of cardiovascular conditions in first-degree relatives, and those with other cardio metabolic diseases (e.g., diabetes or heart diseases), because it takes into account these factors along with other clinically relevant information when determining the prediction results. The prediction results can be used to stratify at-risk patients into different categories who need specific types of preventive intervention.

The exemplary method 200 may be implemented by the information processing module 107 in system 101, previously described with reference to FIG. 1. It should be noted that in the discussion of FIG. 2 and subsequent figures, continuing reference may be made to elements and reference numerals shown in FIG. 1.

At 202, system 101 retrieves patient data. In one implementation, the patient data is stored in the form of one or more computerized patient records (CPRs), which are also known as electronic health records (EHRs). It should be appreciated that other forms are also useful. An exemplary CPR (or EHR) includes information that is collected over the course of a patient's treatment, and typically draws from multiple data sources. As provided in more detail below, an exemplary CPR includes, for example, computed tomography (CT) images, X-ray images, laboratory test results, doctor progress notes, details about medical procedures, prescription drug information, radiological reports, other specialist reports, demographic information, and billing (financial) information. Structured data sources, such as financial, laboratory, and pharmacy databases, generally maintain patient information in database tables. Information may also be stored in unstructured data sources, such as free text, images, waveforms, or physician reports (e.g., dictations). The storage and representation of patient data in databases and its manipulation by software applications suggests the possibility of integration with workflow management systems such as Soarian®, manufactured by Siemens Healthcare, located in Malvern, Pennsylvania.

In one implementation, the patient data includes genetic data and/or non-genetic data (e.g., clinical data). Genetic data includes data that are indicative of genetic risk factors for the cardiovascular condition of interest, and may be collected from a biological sample (e.g., blood) taken from the patient. Non-genetic data generally refers to all other types of data that are indicative of non-genetic risk factors, and may be collected by various methods, such as physical examination of the patient, laboratory measurements and tests, radiological imaging, interview, questionnaire, prior records, or any other suitable means. At the time of assessment when collecting the patient data, the patient may exhibit minimal or no early symptoms of hypertension or any other associated conditions (i.e. patient may be asymptomatic).

Genetic data may include, for example, indicators of the presence or absence of genetic sequence segments or biomarker data, such as single nucleotide polymorphism (SNP) or other polymorphisms in a patient, or other kinds of data measured by genotyping. Genetic polymorphism refers to the co-existence of two or more discontinuous forms of a genetic sequence. SNP, one of the most common polymorphisms, is a small variation occurring within a single nucleotide in a deoxyribonucleic acid (DNA) sequence or other shared sequence. SNPs often occur at or near a gene found to be associated with a certain disease. Therefore, they are often good genetic markers indicative of how humans develop the disease and respond to drugs, chemicals and other agents, and how susceptible or resistant humans are to the disease. For example, the SNP rs16998073 was recently identified to be associated with diastolic blood pressure in a large-scale consortium of studies including around 150,000 patients, and is therefore clinically relevant for assessing the risk of a patient developing hypertension. The SNP rs4852139 has been identified as a genetic marker associated with end products of Glycosylation, which is a process that involves the addition of sugar chains to proteins and lipids. Glycosylated end products, such as glycosylated hemoglobin, have been known to be correlated with the risk of myocardial infarction (MI).

Non-genetic data may include, for instance, pathology data, histological data, biochemical data, personal data, clinical data or any combination thereof. Examples of such data include patient medical history (e.g., prior history of hypertension or other cardio metabolic disease), patient habits (e.g., smoking status, exercise habits, etc.), family history data (e.g., any history of hypertension or other cardio metabolic disease), drug therapy data (e.g., use of diabetic or lipid lowering medication), radiological images (e.g., computed tomography (CT) images, X-ray images, etc.), radiological reports, doctor progress notes, details about medical procedures and/or examinations (e.g., time between first examination and follow-up), demographic information (e.g., age, race, gender, location, etc.), clinic measurement data (e.g., heart-rate, systolic and diastolic blood pressures, mean arterial blood pressure, etc.), laboratory test results, and so forth. Laboratory test results may include measurements of at least one bio-marker found in a biological sample (e.g., urine, blood, etc.) taken from the patient including, for example, glucose, serum insulin, statin, albumin protein, high-density lipoprotein (HDL) cholesterol, low-density lipoprotein (LDL) cholesterol, brain natriuretic peptide (BNP), N-terminal pro b-type natriuretic peptide (NT-proBNP), glycosylated hemoglobin, testosterone, or any other quantifiable characteristic.

In addition, the non-genetic data may further include analytical data derived from the clinical data. For instance, analysis may be performed on the clinical data to generate parameters of clinical significance, such as body mass index (BMI), mean arterial pressure, pulse pressure (PP), double product (DP), non-HDL cholesterol, creatinine clearance, glomerular filtration rate, patient lifestyle data (e.g., stress level), or other biochemical parameters.

At 204, the patient data is used to determine a risk score of the patient developing a cardiovascular condition in future. The risk score may be determined by training a predictive model with historical information (or features) extracted from the patient data. The extraction may be performed using data mining techniques, such as those employed in the REMIND™ system manufactured by Siemens Healthcare, located in Malvern, Pa. Such exemplary data mining techniques are described in “Patient Data Mining,” by Rao et al., U.S. Published Patent Application No. 20030120458, filed Nov. 4, 2002, now U.S. Pat. No. 7,617,078, which is incorporated by reference herein in its entirety. The data mining framework described in that patent application includes a data miner having functions and capabilities that mine medical information from CPRs based on prior domain-specific knowledge. The prior domain knowledge relates to a cardiovascular condition of interest (e.g., hypertension or myocardial infarction), a hospital, etc. It may be generated by input to system 101, or programs that generate information that can be understood by system 101, and stored in a knowledge database. The data miner includes components for extracting information from the CPRs, combining all available evidence in a principled fashion over time, and drawing inferences from this combination process. The mined medical information may then be stored in a structured database.

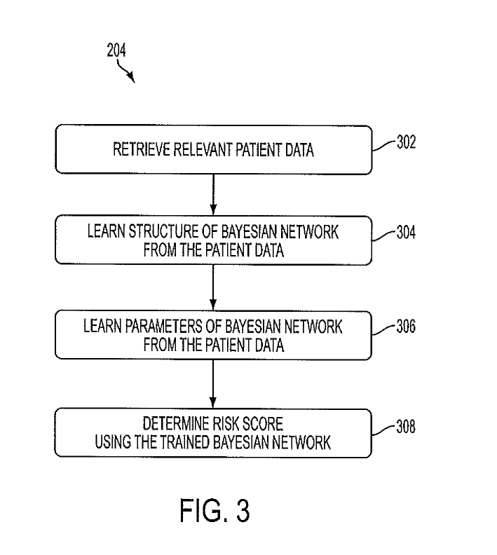

FIG. 3 shows an exemplary method of determining the risk score by using a personalized Bayesian network-based predictive model. It should be appreciated that other predictive data mining models, such as artificial neural networks (ANNs), support vector machines (SVMs), logistic regression, etc., may also be used. A Bayesian network-based model, however, offers two important advantages over the other types of predictive models: (1) accurate prediction in the presence of missing value; and (2) natural interpretability of the model.

More particularly, the Bayesian network readily handles situations where predictor variables are incomplete or missing. This arises due to, for example, imperfect data collection processes (e.g., patient failing to provide accurate answers on questionnaires), lack of accurate assessment and knowledge of patient related factors, cost limitations related to equipment, failure of genetic analysis, etc. Most predictive methods have difficulty in the presence of missing data and often apply a simple averaging method or more complex external imputation method for handling missing values. Bayesian networks can naturally address such missing data as a way to reason under uncertainty by encoding dependencies among the variables. In addition, unlike ANNs or SVMs, which are black boxes to the user, Bayesian networks may also be used to compute marginal and conditional probability distributions on unobserved nodes, thereby offering a natural representation of the uncertainties in decision making medical systems. Moreover, the graphical representation of the Bayesian network enables a meaningful interpretation of causal relationships between different attributes, and provides an effective means to reason about new links and graphs, thereby facilitating understanding about the problem domain.

Bayesian networks are formally represented as directed acyclic graphs, with each node representing a random variable. A link between two nodes indicates a relation between the variables and the direction indicates the causality. Nodes that are not connected represent variables which are conditionally independent of each other. If a node has a known value, it is referred to as an evidence node. In the present context, the variables at each node may represent the presence or absence of certain medical condition (e.g., hypertension or diabetes) or measurable quantity (e.g., glucose level). Each node may be associated with a conditional probability distribution, which represents its parametric dependence relationship with its parents. The probability distribution may be continuous or discrete. A node associated with a continuous probability function may be represented as a Gaussian random variable.

Referring to FIG. 3, at 302, patient data that is clinically relevant to the cardiovascular condition is first retrieved. The relevant patient data may be retrieved from, for example, a structured database populated by a data miner, as previously described.

At 304, the structure of the Bayesian network is learned from the relevant patient data. Given a set of variables X={X₁, X₂, . . . , Xₙ}, the Bayesian network structure S encodes a set of conditional independence assertions about the variables in X, represented as a directed acyclic graph. The search space for building the graph is multimodal, grows rapidly with the number of nodes and includes many local optima (e.g. maxima or minima) that can cause a search method to be stuck. Various types of search methods may be used to find the optimal structure in the search space. In one implementation, the Markov Chain Monte Carlo (MCMC) local search method is employed to learn the structure of the Bayesian network. The MCMC converges to a locally optimal structure faster than other methods, resulting in more accurate structure learning and higher predictive likelihoods on test data. Other search techniques, including global searches such as simulated annealing, ant colony optimization (ACO)-based techniques, or any approximate global search or optimization method, may also be employed.

At 306, the parameters of the Bayesian network are learned from the . relevant patient data. These parameters form part of the conditional probabilities that define the Bayesian network. They are often unknown, and can be estimated from the patient data using, for example, the expectation maximization (EM) approach. EM is a search technique that is well suited to handle the presence of missing values in the dataset. The EM method alternates between solving two problems (E and M steps) to compute the maximum likelihood estimation of the parameters. More specifically, the EM method alternates between computing expected values of the unobserved variables conditional on observed data, while maximizing the complete likelihood (or posterior), assuming that the previously computed expected values are correct. The algorithm starts with random initializations of model parameters to converge onto the optimal point estimate.

At 308, the resulting trained Bayesian network is used to compute a risk score of the patient. In one implementation, the risk score represents the probability that the patient will develop the cardiovascular condition of interest, given the observed patient values included in the network structure, in the near future (e.g., 5 or 10 years). The score may be a numerical value on a predefined scale (e.g., 0 to 100), with higher values corresponding to higher probabilities. It should be appreciated that any other types of representations, including inverse scales or normalized values, may also be used.

The process of computing the posterior of a given node or a subset of nodes in light of evidence observed on the remaining variables is called probabilistic inference. Probabilistic inference may be exact or approximate. Exact inference involves determining the probabilities of the query variables, given the exact state of the evidence variables. Junction tree algorithum, symbolic probabilistic inference (SPI), etc. may be used to perform exact inference. Where exact statistical inference is not possible, approximate inference may be used. To perform approximate inference, the Boyen-Koller algorithm, particle filtering, Gibbs sampling or other suitable technique may be employed.

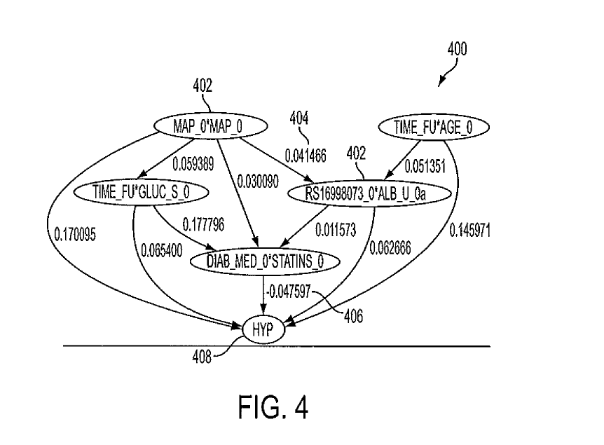

FIG. 4 shows an exemplary Bayesian network-based model 400 trained to predict development of hypertension. The Bayesian network-based model 400 is a complete statistical model that is represented by a directed acyclic graph with weights 404 corresponding to each relationship between two nodes 402. The probability of the patient developing hypertension (or risk score) is represented by node “hyp” 408.

The training and validation test data was obtained from a population-based epidemiological study known as The Study of Health in Pomerania (“SHIP”). See, for example, John U et al., “Study of health in Pomerania (SHIP): a health examination survey in an east German region: objectives and design,” Sozial- und Präventivmedizin, 46(3): 186-194 (2001), which is herein incorporated by reference. The SHIP drew samples from a population aged 20-79 years, using population registries where all German citizens have to be registered. Only individuals with German citizenship and main residency in the study area were included. 7008 subjects were sampled, with 292 persons of each gender in each of the 12 5-year age strata. In order to minimize drop-outs by migration or death, subjects were selected in two waves. The net sample (without migrated or deceased persons) comprised 6267 eligible subjects. Selected persons received a maximum of three written invitations. In case of non-response, letters were followed by a phone call or by home visits if contact by phone was not possible. Data available from 4310 individuals from the SHIP-0 (baseline) and SHIP-1 (follow-up) studies was used to train the Bayesian network-based model 400. The data included: Clinical History (age, medications, BMI, smoking status), genomics (SNPs) and other biomarkers and measurements, including glucose levels (serum), HDL and LDL cholesterol, etc. The goal was to accurately predict prospectively which individuals considered healthy during the SHIP-0 study (baseline) developed hypertension at a follow-up examination (SHIP-1) approximately five years later. Strengths of the present study include the population-representativeness and the high quality of data. Although the study population was split into training and validation sets, the findings were not replicated in independent populations. Therefore, such results should be regarded as hypothesis generating.

In order to construct the Bayesian network-based model, artificial features were first extracted from the training data, Artificial features comprising the combination of products fi*fj for i=1:50; j=i+1:50 were created so as to consider non-linear (e.g., quadratic) interactions among the features. This resulted in 1225 features. An LI-norm Support Vector Machine was applied as a feature selection method using cross-validation in the training set to obtain a small subset of features that were relevant to the classification. The subset of relevant features included patient age (“AGE_{—}0”), mean arterial pressure (“MAP_{—}0”) defined as (2*mean systolic pressure+mean diastolic pressure)/3, time between the first examination and follow-up (“time_fu”), glucose level (“GLUC_S_{—}0”), use of diabetic medications (“diab_med”), use of lipid lowering medications (“Statins_{—}0”), amount of albumin protein (“ALB_U_{—}0”) found in a urine sample, and SNP rs16998703 measurement associated to diastolic blood pressure (“rs16998703”). It should be appreciated that other types of relevant features may also be extracted, depending on the condition of interest.

Referring to FIG. 4, the structure of the Bayesian network-based model 400 was learned from a 5 variable-draft structure based on the extracted features: (MAP_{—}0*MAP_{—}0), (time_fu*AGE_{—}0), (time_fu*GLUC_S_{—}0), (rs16998703*ALB _U_{—}0) and (diab_med*Statins_{—}0). The Bayesian Neural Network (BNN) algorithm was then applied to estimate the weights of the variables 402. See, for example, Eaton D, Murphy K., “Bayesian structure learning using dynamic programming and MCMC,” 2007 Proceedings of the 23nd Annual Conference on Uncertainty in Artificial Intelligence (UAI-07), which is herein incorporated by reference. The means and variances for each feature, as well as the link weights 404, were learned iteratively using an EM algorithm to converge onto their point estimates, maximizing the likelihood of the observed data.

It is interesting to note the negative correlation 406 of the variable (Diab_med*Statins_{—}0) with the probability of developing hypertension 408. A negative link weight between first and second nodes indicates that an increase in the value of the first node will cause a decrease in the value of the second node, while a positive link weight means that an increase in the value of the first node will cause the value of the second node to increase. The interaction between antidiabetic medication and statins with regard to an inverse association with incident hypertension represents a key finding of this study. This result may, at least in subjects with diabetes, indicate an antihypertensive effect of statins. This is in line with previous studies demonstrating possible pleiotropic antihypertensive effects of statins.

Another interesting finding is the interaction between albuminuria and rs16998073, which can be used to predict hypertension in asymptomatic patients. The SNP rs16998073 was recently identified to be associated with diastolic blood pressure in a large-scale consortium of studies including ˜150,000 participants. The exact mechanism behind the interaction of the SNP with albuminuria with respect to incident hypertension, however, deserves further research.

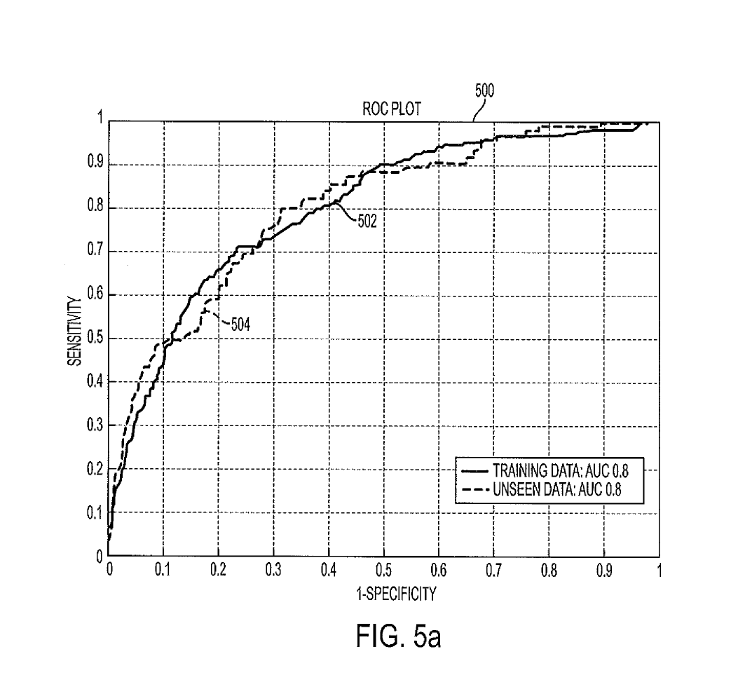

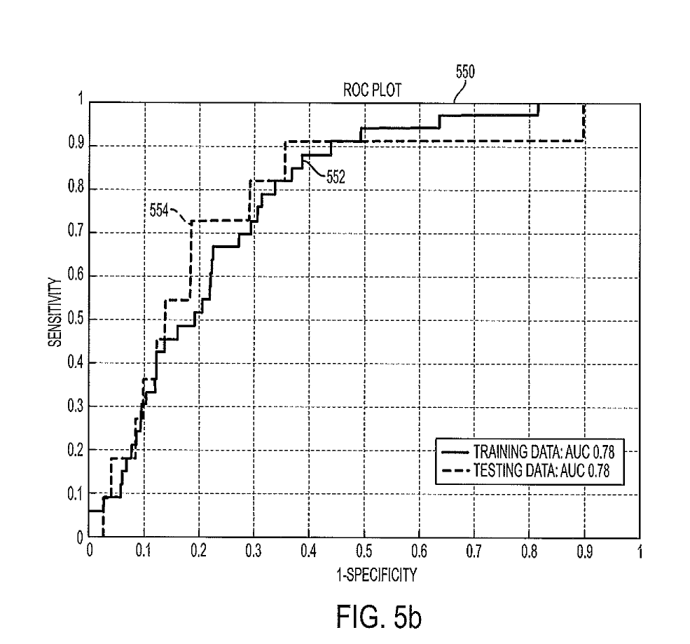

FIG. 5a shows an exemplary receiver operating curve (ROC) 500 corresponding to the trained Bayesian network-based model 400 for predicting hypertension. As discussed previously, the main cohort was randomly split into training data (70%) and unseen testing data (30%) until the final model was trained. The area under the ROC curve (AUC) for the training data set 502 was 0.802. This was almost identical to the performance achieved for the unseen test data set 504, with an AUC of 0.796.

FIG. 5b shows another exemplary ROC 550 obtained by a predictive model trained to predict myocardial infarction (MI). The experimental cohort set comprises 4310 individuals from the SHIP database who are not considered hyper tense. The cohort set was randomly split into a training set (70%) for training the predictive model and an unseen testing set (30%) for validating the model. Of these 4310 individuals, 44 of them suffered an MI between the SHIP-0 and SHIP-1 examinations. A subset of relevant features was extracted from the training set to construct the predicitive model. The relevant features include patient age, percentage level of Glycosylated hemoglobin, smoking status, testosterone level, blood pressure, and SNP rs4852139 measurement. As shown in FIG. 5b, the area under the ROC curve (AUC) for the training set 552 was 0.78, which was almost identical to the performance achieved by the unseen testing set 554 with an AUC of 0.78.

Once the risk score is obtained, it may be used to classify the patient into a risk category. Referring back to FIG. 2, at 206, the patient is classified into at least one of multiple risk categories in accordance with the risk score. By stratifying at-risk patients into different risk categories, a personalized preventive strategy associated with the selected risk group can be recommended to prevent the onset of the cardiovascular condition of interest. In one implementation, the risk categories are grouped into at least first and second types based on the risk score. For example, patients having lower risk scores (e.g., 50 or less) are classified into categories associated with non-compelling indications of hypertension, while patients having higher risk scores (e.g., 51-100) are classified in categories associated with compelling indications. The first and second types may further be subdivided into multiple sub-categories (e.g., stages 1, 2, etc.) according to the risk score. It should be appreciated that other types of categorizations, including further levels of sub-categorization, may also be used.

At 208, a personalized report is presented with a recommendation of the preventive strategy associated with the selected risk category. Various types of preventive intervention can be recommended according to commonly used guidelines, Exemplary preventive measures to prevent the onset of the disease include prescribing lipid lowering drugs, lifestyle modification, more regular monitoring with further testing, referral to another physician, and so forth.

In one implementation, system 101 presents a personalized report with the automatically selected recommendation and/or associated results (e.g., risk score, risk category, etc.). In addition, various analytical parameters, raw laboratory readings, genetic data or any other patient information of clinical significance to predicting the cardiovascular condition of interest may also be presented in the report. Examples of such information include, for example, patient's age, mean arterial pressure, time between the first examination and follow-up, glucose level, presence of diabetic and lipid lowering medication, amount of albumin protein found in the urine sample, SNP measurements (e.g., rs16998703) associated to diastolic blood pressure, or any combination thereof, The report may be immediately made available to the primary care physician or any other medical practitioner to aid in making decisions about the patient's follow-up and preventive treatment choice. Presentation of the report may be in the form of, for example, an electronic medical record, a printed report, pop-up alert message box at a display or communication device, or any other suitable means. In addition, the report may be presented as a communication message sent directly to the medical practitioner to alert the medical practitioner about a patient's high risk score. The communication message may be sent via, for example, electronic mail (email), facsimile, voice message, short message service (SMS) text, presence system, social media network (e.g., Twitter), and so forth.

The present framework may also be used to streamline a diagnostic workflow. In one implementation, a diagnostic workflow is initiated with laboratory tests, in-clinic examinations, and/or collection of other patient information from patients. The information collection may be performed as part of an annual screening examination of a cohort of patients associated with certain characteristics. For example, the cohort may include certain patients at risk for hypertension due to family history of hypertension among first-degree relatives, and/or patients with other cardio metabolic diseases (e.g., diabetes or heart diseases). In another example, the cohort may include patients at risk for MI because of family history of cardiac disease or chronic hypertension among first-degree relatives, or patients with other cardio metabolic diseases and/or other relevant factors.

In one implementation, the results of the present framework, including any recommendation of preventive strategies, are presented to a primary care physician as an interpretation report. Besides the recommendation, the interpretation report may also include raw laboratory readings or test results. The interpretation report may be sent in printed or electronic form directly from the laboratory to the primary physician. The interpretation report may provide decision support to aid the physician in assessing the risk of the patient developing a cardiovascular condition in the near future. Based on the report, the physician may recommend an optimal preventive strategy. In addition, the recommendation may be entered into the system 101 to be used as further input for monitoring the patient or for subsequent risk assessment in future years. Alternatively, or in combination thereof, the system 101 may automatically create one or more task items in accordance with the recommended preventive strategy. The task items may be entered as instructions into a computerized physician order entry (CPOE) system, which manages and communicates the instructions to medical practitioners (e.g., physician, radiologist, pharmacist, nurse, etc.) for treating patients under their care. The task items may also be entered into , a clinical workflow management system as steps to be completed by the medical practitioners to treat patients under their care.

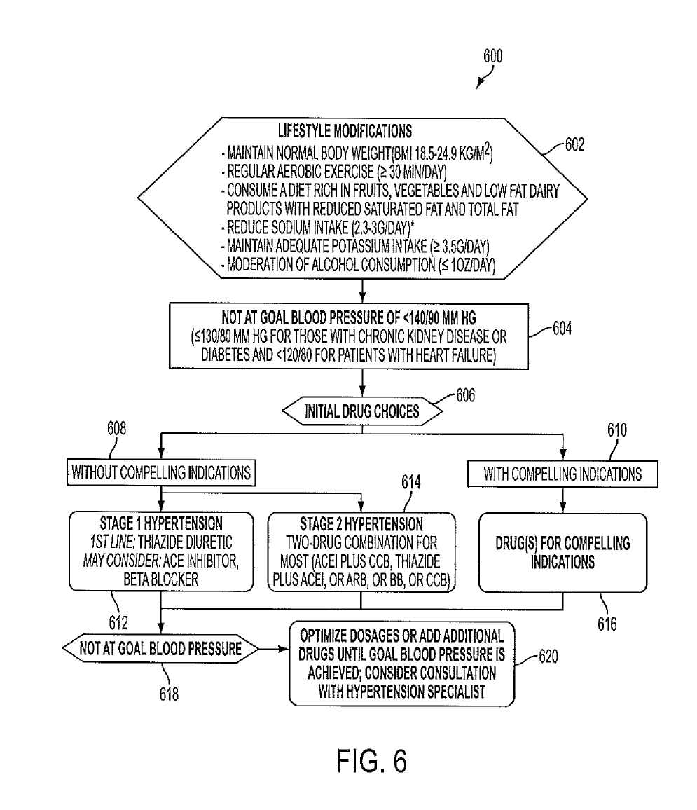

FIG. 6 shows an exemplary process 600 for continuous monitoring, prevention and/or treatment of the hypertension. At 602, lifestyle modifications are recommended to lower the risk of subsequent hypertension in patients identified as being at risk (e.g., patients with risk score above a certain predetermined level). Such lifestyle modifications include, for example, maintaining normal body weight, regular aerobic exercise, dietary changes, sodium intake reduction, maintaining adequate potassium intake, moderating alcohol consumption, etc. The goal of such lifestyle modifications is to lower or maintain the blood pressure at a desired level (e.g., <140/90 mm Hg). System 101 may recommend such lifestyle modifications as primary prevention for asymptomatic (i.e. healthy) patients or secondary prevention for patients who have already experienced an acute coronary event (e.g., heart failure).

At 604, if the desired blood pressure is not achieved, system 101 may present further recommendations of preventive measures. For example, at 606, an initial drug choice may be offered according to the risk category associated with the patient. In one implementation, patients within the risk category 608 associated with non-compelling indications (or low risk score) may be further classified as Stage 1 and Stage 2 according to lower and higher risk scores respectively. At 612, patients associated with the Stage 1 hypertension risk category may be prescribed thiazide diuretic, angiotensin-converting enzyme (ACE) inhibiting medication, beta blockers, or any other suitable medication. At 614, patients in the Stage 2 hypertension risk category may be prescribed, for example, a multi-drug combination. Exemplary combinations include ACE inhibitor with CCB, or thiazide with ACEI, ARB, BB or CCB. At 616, patients within the risk category 610 associated with compelling indications (or high risk score) may be prescribed with certain drugs.

At 618, if the desired blood pressure is not achieved, system 101 may recommend additional preventive measures. For example, at 620, the dosage of medication may be optimized, modified or additional drugs added until the target blood pressure is achieved. System 101 may also recommend that the patient consult with a hypertension specialist. It is understood that other preventive measures may also be recommended.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

Further, although method or process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required,

1. A method of predicting development of a cardiovascular condition of interest in a patient, comprising:
retrieving patient data associated with the patient including genetic data and non-genetic data;
(ii) determining, using prior domain knowledge relating to the cardiovascular condition of interest, a risk score as a function of the patient data; and
(iii) classifying, according to the risk score, the patient into at least one of multiple risk categories, wherein the multiple risk categories are associated with different preventive strategies.

2. The method of claim 1 further comprises presenting a report recommending the preventive strategy associated with the at least one of multiple risk categories.

3. The method of claim 1 wherein the genetic data comprises single nucleotide polymorphism (SNP) marker data.

4. The method of claim 1 wherein the non-genetic data comprises pathology data, histological data, biochemical data, personal data, clinical data, or any combination thereof.

5. The method of claim 1 wherein the non-genetic data comprises patient medical history, patient habits, family history data, drug therapy data radiological images, radiological reports, doctor progress notes, details about medical procedures and/or examinations, demographic information, clinic measurement data, laboratory test results, or any combination thereof.

6. The method of claim 5 wherein the laboratory test results comprise measurements of at least one bio-marker found in a biological sample taken from the patient.

7. The method of claim 6 wherein the bio-marker comprises glucose, serum insulin, statin, albumin protein, high-density lipoprotein (HDL) cholesterol, low-density lipoprotein (LDL) cholesterol, brain natriuretic peptide (BNP), N-terminal pro b-type natriuretic peptide (NT-proBNP), glycosylated hemoglobin, testosterone, or any combination thereof.

8. The method of claim 1 wherein the step (ii) comprises:
training a predictive model using features mined from the patient data; and
determining the risk score via the predictive model.

9. The method of claim 8 wherein the predictive model comprises a neural network-based predictive model.

10. The method of claim 8 wherein the predictive model comprises a Bayesian network-based predictive model.

11. The method of claim 10 further comprising learning a structure of the Bayesian network-based predictive model by performing a Markov Chain Monte Carlo (MCMC) search, simulated annealing, or an ant colony optimization (ACO)-based technique.

12. The method of claim 10 further comprising learning one or more parameters of the Bayesian network-based predictive model by performing an expectation-maximization method.

13. The method of claim 8 further comprising performing a probabilistic inference to compute the risk score, wherein the risk score represents a probability that the patient will develop the cardiovascular condition given observed values in the predictive model.

14. The method of claim 1 wherein the multiple risk categories are grouped into at least first and second groups, the first group is associated with non-compelling indications of the cardiovascular condition of interest while the second group is associated with compelling indications of the cardiovascular condition of interest.

15. The method of claim 14 wherein at least the first or second group is sub-divided into sub-groups of risk categories.

16. The method of claim 1 wherein the preventive strategies comprise lifestyle modification, prescription of medication, regular monitoring, further testing, referral to another physician, or any combination thereof.

17. The method of claim 16 wherein the lifestyle modification comprises maintaining normal body weight, regular aerobic exercise, dietary changes, sodium intake reduction, maintaining adequate potassium intake, moderating alcohol consumption, or any combination thereof.

18. The method of claim 2 further comprising presenting at least one additional recommendation if a desired blood pressure is not achieved.

19. The method of claim 1 wherein the patient, at a time of assessment when collecting the patient data, is asymptomatic.

20. The method of claim 1 further comprises automatically creating one or more task items in accordance with the preventive strategy associated with the at least one of multiple risk categories.

21. The method of claim 1 wherein the cardiovascular condition of interest comprises hypertension.

22. The method of claim 1 wherein the cardiovascular condition of interest comprises myocardial infarction or stroke.

23. A non-transitory computer readable medium embodying a program of instructions executable by machine to perform steps for predicting development of a cardiovascular condition of interest in a patient, the steps comprising:
(i) retrieving patient data associated with the patient including genetic data and non-genetic data;
(ii) determining, using prior domain knowledge relating to the cardiovascular condition of interest, a risk score as a function of the patient data; and
(iii) classifying, according to the risk score, the patient into at least one of multiple risk categories, wherein the multiple risk categories are associated with different preventive strategies.

24. A healthcare information technology system, comprising:
a memory device for storing non-transitory computer readable program code; and
a processor in communication with the memory device, the processor being operative with the computer readable program code to:
(i) retrieve patient data associated with a patient including genetic data and non-genetic data;
(ii) determine, using prior domain knowledge relating to a cardiovascular condition of interest, a risk score as a function of the patient data; and
(iii) classify, according to the risk score, the patient into at least one of multiple risk categories, wherein the multiple risk categories are associated with different preventive strategies.
